(19) United States
(12) Patent Application Publication
(10) Pub. No.: US 2025/0348393 A1
(43) Pub. Date: Nov. 13, 2025

(54) Soft Error Rate Evaluation System

(71) Applicant: Hitachi, Ltd., Tokyo (JP)

(72) Inventors: Takumi UEZONO, Tokyo (JP); Tadanobu TOBA, Tokyo (JP); Kenichi SHIMBO, Tokyo (JP)

(21) Appl. No.: 19/077,227

(22) Filed: Mar. 12, 2025

(30) Foreign Application Priority Data
May 7, 2024 (JP) 2024-075050

(51) Int. Cl. G06F 11/26; G06F 17/18

(52) U.S. Cl. CPC G06F 11/26; G06F 17/18

(57) ABSTRACT

To construct a soft error rate evaluation system which quickly evaluates a change in soft error rate due to a program change. The soft error rate evaluation system which evaluates the radiation resistance of electronic equipment includes: (a) a procedure of extracting a first feature amount at the time of execution of each of a plurality of irradiation evaluation programs from the plurality of irradiation evaluation programs and their program input conditions; (b) a statistical analysis modeling procedure of performing statistical analysis modeling from the first feature amount of each of the plurality of irradiation evaluation programs and a soft error rate for each of the plurality of irradiation evaluation programs obtained in a neutron irradiation test conducted in advance, to generate a statistical analysis model; (c) a procedure of extracting a second feature amount at the time of execution of an evaluation target program from the evaluation target program and its program input conditions; and (d) a soft error rate calculation procedure of calculating a soft error rate of the evaluation target program from the second feature amount of the evaluation target program by using the statistical analysis model.

### CLAIM OF PRIORITY

The present application claims priority from Japanese Patent Application JP 2024-075050 filed on May 7, 2024, the content of which is hereby incorporated by reference into this application.

### BACKGROUND OF THE INVENTION

The present disclosure relates to a soft error rate evaluation system, and particularly to a soft error rate evaluation system which evaluates a soft error rate caused by radiation, etc. in a logic semiconductor device whose operation is changed by a software program such as a processor, and in an electronic system with the logic semiconductor device mounted thereon.

There has been described in Japanese Unexamined Patent Application Publication No. 2014-160421, a soft error analysis device and an error information creating device. The soft error analysis device analyzes impact caused in a target microcomputer by generating a soft error into a simulator of the target microcomputer, and includes: error information storing means in which error contents or error occurrence places are registered; function block identifying means which identifies a running function block; and error setting means which reads the error content of the function block identified by the function block identifying means or a probability of occurrence of the error at the error occurrence place from the error information storing means, and sets a soft error into the simulator in accordance with at least either the error content or the error occurrence place.

### SUMMARY OF THE INVENTION

With the rise of automation technologies such as mobility systems and industrial equipment, the reliability of electronic systems has recently become important increasingly. At the same time, the electronic system has become more complex and large-scale, and estimating the impact that failures in modules constituting the electronic system are exerted on the system becomes important for improving reliability and stability. Amon the failures, a soft error which is an event with low reproducibility in particular is one of failure factors that requires the most consideration. The evaluation of the impact on the electronic system due to radiation which is the main cause of the soft error is carried out through a radiation evaluation test. In particular, in electronic equipment used on the earth, a neutron evaluation test has been conducted because the radiation that becomes the main cause of soft errors is neutrons. Among the electronic systems, a neutron irradiation evaluation test method has been standardized for memory devices (memory semiconductor devices). However, for a logic semiconductor device such as a processor, a microcomputer or the like, in which the operation thereof changes depending on the programs to be executed, the neutron irradiation evaluation test method has not been standardized, and no de facto method has been proposed either.

Further, in a space industry sector as well, efforts to make good use of commercial off-the-shelf (COTS) parts rather than using dedicated electronic components and systems for space-related equipment have been made. There has been a demand for COTS reliability evaluation in the space environment where radiation flies, and for an improvement in the reliability of the electronic system using COTS.

On the other hand, it is known that the rate of neutron-induced soft errors in the logic semiconductor device such as the processor and the microcomputer or the like depends on the program to be executed. Therefore, when evaluating the soft error rate of the electronic system incorporating the processor or the microcomputer therein, the electronic system is irradiated with neutrons while the program when the electronic system is actually used is executed, or while a general benchmark program is executed, thereby evaluating the soft error rate. However, in recent years, software updates via OTA (Over the Air: a technology for sending and receiving data via wireless communication when performing software updates, etc.) and agile design (agile is an iteration (iterative) method of advancing development while repeating four phases (sprints) of planning, design, implementation, and testing) are becoming more common. It is becoming increasingly common for the execution programs of the electronic system to change during the product lifecycle of the electronic system. In this way, when the execution program used in the electronic system is changed, the soft error rate also changes. It is therefore necessary to reevaluate the soft error rate for the changed execution program. Currently, in order to obtain the soft error rate when the changed program is executed, the only option is to conduct the neutron irradiation evaluation test again for each program change. There are problems such as high cost and a long evaluation time (long TAT: Turn Around Time). Further, long-term operation in harsh environments such as the space industry sector requires higher reliability than on the earth, and it is considered to be necessary that the impact of the loaded program on the soft error rate is evaluated in detail. However, it is necessary to conduct evaluation tests of multiple programs. Similarly to the above, there are problems such as high cost and a long evaluation time.

The present disclosure has been made in view of the above points, and aims to construct a soft error rate evaluation system which quickly evaluates changes in soft error rate due to program changes, in an electronic system including a processor and a microcomputer whose programs are changed during the life cycle of an electronic product and an electronic system. Thus, the purpose is to evaluate the soft error rate without conducting the neutron irradiation evaluation test, and realize a reduction in the cost of the neutron irradiation evaluation test and the shortening of a soft error rate evaluation time.

A soft error rate evaluation system according to one aspect of the present disclosure is a soft error rate evaluation system which evaluates the radiation resistance of electronic equipment which adopts a logic semiconductor device. The soft error rate evaluation system includes: (a) a procedure of extracting a first feature amount at the time of execution of each of a plurality of irradiation evaluation programs from the plurality of irradiation evaluation programs and their program input conditions;
(b) a statistical analysis modeling procedure of performing statistical analysis modeling from the first feature amount of each of the plurality of irradiation evaluation programs and a soft error rate for each of the plurality of irradiation evaluation programs obtained in a neutron irradiation test conducted in advance, to generate a statistical analysis model;
(c) a procedure of extracting a second feature amount at the time of execution of an evaluation target program from the evaluation target program and its program input conditions; and
(d) a soft error rate calculation procedure of calculating a soft error rate of the evaluation target program from the second feature amount of the evaluation target program by using the statistical analysis model.

That is, the soft error rate evaluation system according to one aspect of the present disclosure constructs a statistical analysis model as a radiation soft error rate model for a logic semiconductor device such as a target processor or a microcomputer device through a single neutron irradiation evaluation test. By constructing the statistical analysis model in advance in this way, there can be provided a soft error rate evaluation system which can evaluate the radiation soft error rate using the radiation soft error rate model without conducting the neutron irradiation test when the execution program in the electronic system equipped with the processor or microcomputer is changed.

According to the soft error rate evaluation system of one aspect of the present disclosure, when there is a program change in an electronic system including a processor or a microcomputer, radiation soft error rate evaluation can be conducted at reduced cost and in a short TAT.

Objects, configurations, and effects other than the above will be apparent from the description of the following embodiments.

### BRIEF DESCRIPTION OF THE DRAWINGS

FIG. 1 is a view showing a configuration example of a soft error rate evaluation system according to an embodiment of the present disclosure.

FIG. 2 is a view showing a configuration example of a program feature amount extraction part shown in FIG. 1.

FIG. 3 is a view showing a configuration example of trace data in FIG. 2.

FIG. 4 is a view showing a processing flow of an in-memory data stay time count part in FIG. 2.

### DETAILED DESCRIPTION OF THE PREFERRED EMBODIMENTS

Hereinafter, embodiments of the present disclosure will be described with reference to the accompanying drawings. In the following embodiments, when referring to the number of elements, etc., unless otherwise specified and clearly limited in principle to a specific number, the number is not limited to the specific number and may be more or less than the specific number.

Further, in the following embodiments, their components are not necessarily essential unless specified stated otherwise and unless it is clearly considered not to be essential in principle.

Similarly to the above, in the following embodiments, when referring to the shape, positional relationship, etc. of components, etc., it is intended to include those that are substantially similar or approximate to those shapes, etc., unless otherwise specified and unless it is clearly considered not to be the case in principle. This means that the same applies to the above numerical values and ranges.

Also, in all the drawings for describing the embodiments, in principle, the same members are given the same reference numerals, and their repeated description will be omitted. Hereinafter, embodiments of the present disclosure will be described with reference to the accompanying drawings.

### EMBODIMENT

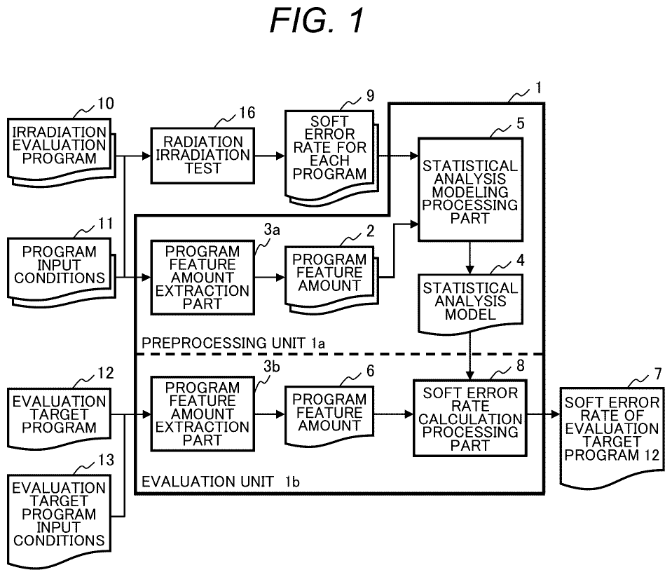

FIG. 1 is a view illustrating a configuration example of a soft error rate evaluation system according to an embodiment of the present disclosure. In this example, the soft error rate evaluation system 1 includes a processor soft error rate evaluation system as a representative example.

As shown in FIG. 1, the soft error rate evaluation system 1 is roughly divided into two parts of a preprocessing unit 1a which performs processing up to the generation of a statistical analysis model 4 as a radiation soft error rate model, and an evaluation unit 1b which evaluates a soft error rate of a program 12 to be evaluated.

The preprocessing unit 1a is comprised of a program feature amount extraction part 3a which extracts a program feature amount 2 used for soft error rate calculation from a program executed on a processor or a microcomputer, and a statistical modeling processing part 5 which generates a statistical analysis model 4 using the program feature amount 2 for each program as an input and soft error rate data for each program as an output. The program feature amount 2 can be rephrased as a first feature amount. The statistical modeling processing part 5 may be rephrased as a statistical analysis modeling processing part.

The evaluation unit 1b is comprised of a program feature amount extraction part 3b which extracts a program feature amount 6 used for soft error rate calculation from the evaluation target program 12, and a soft error rate calculation processing part 8 which calculates a soft error rate 7 of the evaluation target program 12 using the statistical analysis model 4 and the program feature amount 6. The program feature amount 6 can be rephrased as a second feature amount.

The soft error rate evaluation system 1 shown in FIG. 1 can be configured by a hardware circuit. Further, the soft error rate evaluation system 1 shown in FIG. 1 can also be configured by executing a software program such as a soft error rate evaluation program by a data processing device.

An operational overview will be described below.

As a preliminary preparation, it is necessary to prepare a soft error rate 9 for each program, which is data to be input to the soft error rate evaluation system 1. In order to obtain the soft error rate 9 for each program, a radiation irradiation test 16 is performed on an electronic system to be evaluated which is equipped with the program (the electronic system having a processor or a microcomputer which executes the program) by irradiating the electronic system with radiation (for example, neutron rays) generated by a particle accelerator or the like in a state in which an irradiation evaluation program 10 is executed based on program input conditions 11 (input pattern). The soft error rate 9 for each program can be obtained by acquiring defect information caused by soft errors which occur due to nuclear reactions in a semiconductor device that constitutes a processor or a microcomputer. Here, the irradiation evaluation program 10 may be a function verification program, or may be a program which has been designed to make modeling easier by greatly changing the program feature amount 2 to be described later between programs. Further, as error information (defect information), there are considered a method of saving as expected values in advance, the results of executing a program with the electronic system to be evaluated, comparing the expected values with the output results of the electronic system during radiation exposure, and deeming any difference from the expected values to be an error, or a method of treating as an error, information obtained by an error detection mechanism included in the electronic system to be evaluated.

As the operation of the soft error rate evaluation system 1, first, the program feature amount 2 is extracted from the irradiation evaluation program 10. Here, in order to determine the operating conditions of the program, the program input conditions 11 are also used in addition to the irradiation evaluation program 10. Further, the program feature amount 2 needs to select those suitable for constructing the statistical analysis model 4, that is, feature amounts highly sensitive to the soft error rate. As the feature amounts highly sensitive to the soft error rate, there are considered, for example, (1) the number of times each instruction is executed during program execution and (2) the residence time of data in a memory (or memory element).

Regarding (1), a functional part (also called a functional block) used within a processor is different for each instruction executed on the processor, and each functional part has a different soft error rate according to its circuit structure. Therefore, the feature amount of the number of times each instruction is executed (≈the number of times each functional block is used) becomes highly sensitive to the soft error rate.

Regarding (2), since as a mechanism, soft errors occur by collision of radiation such as neutrons against a semiconductor device, the more the radiation is irradiated, the higher the possibility of soft errors occurs.

Generally, in the ground environment, the radiation dose per unit time does not change in a short term, and the irradiation amount of radiation is proportional to the irradiation time thereof. Therefore, the possibility of occurring of a soft error is proportional to the irradiation time of radiation. On the other hand, when considering the semiconductor device side, the majority of soft errors basically occur within each memory element, but even if a soft error occurs and causes a change in the data held in the memory, it will not appear as an error unless the changed data is used by a program. Therefore, a soft error will appear as an error only when it occurs during time from when data is stored in the memory element until it is finally read out (data residence time).

From the above, it is considered that the longer the time when the data stays in the memory (or memory element), the longer the radiation irradiation time is and the higher the soft error rate is. This is considered to be suitable as a feature amount. However, the feature amount is not limited to the above. For example, general feature amounts such as execution time, memory usage, the number of lines of codes, cyclomatic complexity, etc. may be used. Incidentally, the memory is, for example, a plurality of registers provided in the processor, or a plurality of flip-flop circuits constituting each register. Further, the memory also includes a plurality of memory cells of an SRAM (static random access memory) provided in a processor or a microcomputer.

Next, the statistical analysis modeling processing is performed by the statistical modeling processing part 5 using the soft error rate 9 for each irradiation evaluation program 10 described above and the program feature amount 2. Here, as the statistical analysis model 4, for example, a multiple regression analysis model is considered. The preprocessing unit 1a performs processing up to generating the statistical analysis model 4, which is executed only once.

Next, the transition to the operation of the evaluation unit 1b is performed. The evaluation unit 1b is a unit to be re-executed every time the execution program and the operating conditions, that is, the evaluation target program 12 and evaluation target program input conditions 13 change. First, the program feature amount 6 is extracted from the evaluation target program 12. The program feature amount extraction part 3b performs the same processing as the program feature amount extraction part 3a of the preprocessing unit 1a.

Next, using the statistical analysis model 4, the soft error rate calculation processing part 8 performs soft error rate calculation processing, and calculates the soft error rate 7 of the evaluation target program 12.

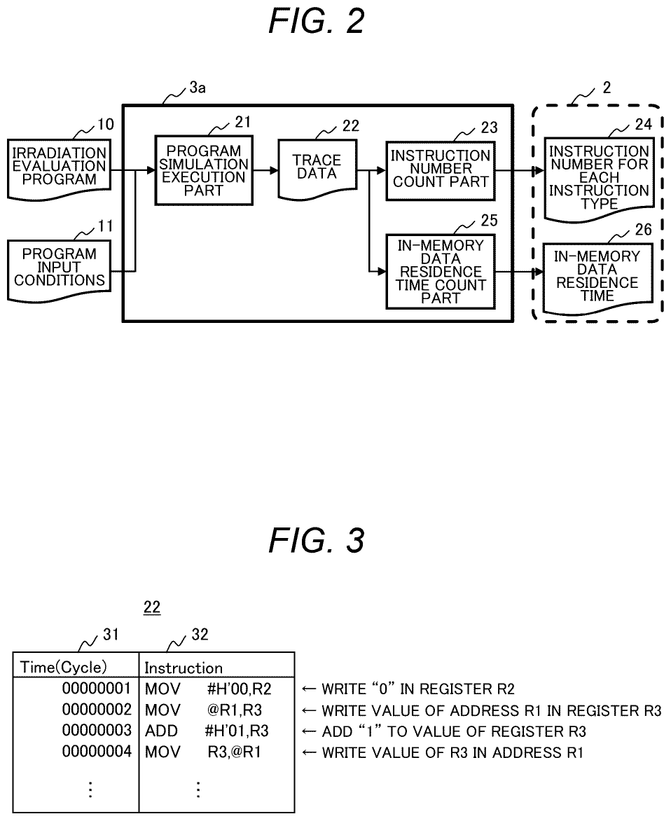

Next, description will be made about a configuration example of the program feature amount extraction part (3a, 3b) with reference to FIG. 2. FIG. 2 is a view illustrating a configuration example of the program feature amount extraction part of FIG. 1. In the present configuration example, the inputs and outputs (10, 11, 2) of the program feature amount extraction part 3a when used in the preprocessing unit 1a are described. The inputs and outputs of the program feature amount extraction part 3b become (12, 13, 6) as shown in FIG. 1 when used in the program feature amount extraction part 3b of the evaluation unit 1b. Further, here, processing for one set of programs (irradiation evaluation program 10) and input conditions (program input conditions 11) will be described as a representative example.

The program feature amount extraction part 3a is comprised of a program simulation execution part 21, an instruction number count part 23, and an in-memory data residence time count part 25. The program simulation execution part 21 uses an irradiation evaluation program 10 as an irradiation test program and program input conditions 11 to cause an electronic system to be evaluated to execute the program simulatively, and outputs trace data 22 from the electronic system to be evaluated. The instruction number count part 23 counts the number of instructions for each instruction written in the trace data 22 and outputs an instruction number 24 for each instruction type. The in-memory data residence time count part 25 analyzes the trace data 22 and outputs an in-memory data residence time 26. It is conceivable to use a general debugger as the program simulation execution part 21. A detailed explanation of the configuration example of the program feature amount extraction part 3b will be omitted as it can be easily understood by those skilled in the art, but the input to the program simulation execution part 21 becomes the evaluation target program 12 and evaluation target program input conditions 13. The output of the program simulation execution part 21 becomes the program feature amount 6.

A configuration example of the trace data 22 will be described with reference to FIG. 3. FIG. 3 is a view showing the configuration example of the trace data in FIG. 2. Here, the trace data 22 includes enumerated data of instructions executed in the program. Further, the trace data 22 includes at least an execution instruction (Instruction) 32 and an execution timing (Time) 31. The instruction number count part 23 counts the number of instructions included in the sequence of execution instructions 32 in the trace data 22. The in-memory data residence time count part 25 focuses on each register description (in the example of FIG. 3, “Rx” where x is a register number) included in the trace data 22 and counts the time taken until the data written in the register Rx is finally read out, as the in-memory data residence time. When the data is written in the register Rx two or more times, two or more in-memory residence times are derived, and the sum of these is regarded as the in-memory data residence time.

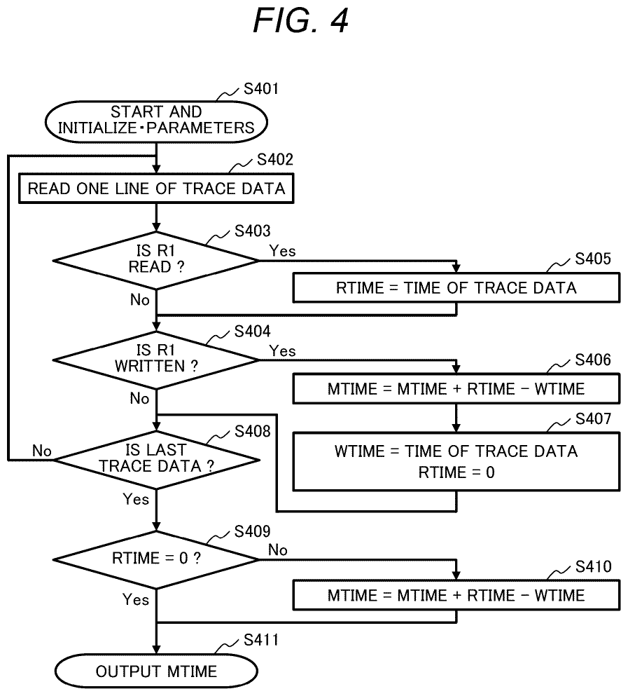

Next, description will be made about a processing flow of the in-memory data residence time count part 25 with reference to FIG. 4. FIG. 4 is a view showing the processing flow of the in-memory data residence time count part in FIG. 2. FIG. 4 shows, as an example, a processing flow for a register R1 of the in-memory data residence time count part 25. However, in the case where there are a plurality of registers Rx (where x=1 to j: j is a positive number), the in-memory data residence time count part 25 performs similar processing even on a register R2 and subsequent registers and adds up the data residence times output by each processing. Respective steps (S401-S411) will be described below.

At the start of processing, parameters are initialized (S401). Here, the parameters are WTIME indicating the time when data is written in the register R1, RTIME indicating the time when data is read out from the register R1, and MTIME indicative of the sum of data residence times in the register R1. All the parameters are initialized to 0.

Next, one line (one set of data on an execution instruction and execution timing) is read from the trace data 22 (S402).

It is determined whether the read trace data is reading the register R1 (S403) or writing into the register R1 (S404).

If the register R1 has been read (Yes in S403), the execution timing described in the read trace data is stored in RTIME (S405). Then, the processing flow proceeds to S404.

If the register R1 has been written (No in S403, Yes in S404), the time from the previous writing time (WTIME) to the last reading time (RTIME) is added to MTIME (S406). Next, the execution timing described in the trace data is stored in WTIME, and RTIME is initialized (S407). Then, the processing flow proceeds to S408

In S403 to S407, the processing for the trace data read in S402 is completed, and it is determined whether there is any trace data to be read next (whether the trace data read in S402 is the last) (S408). When the trace data read in S402 is not the last (No in S408), the processing flow returns to S402, and the processing is continued. When the trace data read in S402 is the last (Yes in S408), it is determined whether there is any register residence time that has not been added to MTIME, and if there is register residence time that has not been added to MTIME, the processing of adding it to MTIME is performed. This processing first determines whether the parameter RTIME is 0 (S409).

When the parameter RTIME is 0 (Yes in S409), it means that the register R1 has not been read since final writing to the register R1, or that RTIME has not changed since it was initialized (S401) (the register R1 has not been used). Therefore, MTIME is output without any processing, and the processing flow comes to an end (S411).

On the other hand, when RTIME is not 0 (No in S409), it means that data was last written into the register R1 and then read out from the register R1. Therefore, the data residence time (RTIME-WRITE) is added to MTIME (S410), MTIME is output, and the processing flow is terminated (S411).

A specific example of the statistical modeling processing part 5 will be shown below. As the statistical analysis model 4, an example using a first-order polynomial approximation model of program feature amounts is shown in (Equation 1).

$$\begin{matrix}[ Expression 1 ] & \\ S = {\sum }_{i = 1}^{n} {a}_{i} \cdot {F}_{i} & ( Equation 1 )\end{matrix}$$

Here, S indicates the soft error rate, Fi indicates the program feature amount, ai indicates the model coefficient, and n indicates the number of program feature amounts. Here, n is a positive integer. In the above equation, by substituting S for the soft error rate 9 for each program and Fi for the program feature amount 2, an equation with ai as a variable can be obtained by the number of irradiation evaluation programs 10 (assumed to be m). Here, if n=m, the model coefficient can be obtained by solving simultaneous equations. Further, if n<m, it results in an overdetermined system, and hence a plausible solution can be obtained by performing statistical analysis processing. Therefore, the number of the irradiation evaluation programs 10 needs to be greater than the number of the feature amounts. It is conceivable to use, for example, a multiple regression analysis model as the statistical analysis processing. Other statistical analysis methods include ridge regression, lasso regression, etc.

As described above, the soft error rate evaluation system 1 for evaluating the radiation resistance of electronic equipment with logic semiconductor devices adopted therein includes the following procedures.

(a) A procedure (program feature amount extraction part 3a) for extracting, from the plural irradiation evaluation programs 10 and their program input conditions 11, a first feature amount 2 when each of the plural irradiation evaluation programs 10 is executed.

(b) A statistical analysis modeling procedure (statistical modeling processing part 5) for generating a statistical analysis model 4 as a radiation soft error rate model by performing statistical analysis modeling from the first feature amount 2 of each of the plural irradiation evaluation programs 10 and the soft error rate 9 for each of the plural irradiation evaluation programs 10 obtained in the neutron irradiation test 16 conducted in advance.

(c) A procedure for extracting a second feature amount 6 at the time of execution of the evaluation target program 12 from the evaluation target program 12 and its program input conditions 13 (program feature amount extraction part 3b).

(d) A soft error rate calculation procedure (soft error rate calculation processing part 8) for calculating the soft error rate of the evaluation target program 12 using the statistical analysis model 4 from the second feature amount 6 for the evaluation target program 12.

The procedures (a) and (b) are performed by the preprocessing unit 1a, and the procedures (c) and (d) are performed by the evaluation unit 1b. Further, when the soft error rate evaluation system 1 is configured by a software program like a soft error rate evaluation program, the procedures (a), (b), (c), and (d) may be configured by the soft error rate evaluation program.

The first feature amount 2 and the second feature amount 6 include at least the number of executions of each instruction which is a feature amount corresponding to the soft error rate for each functional block included in the logic semiconductor device, and the in-memory data residence time. The number of executions of each instruction is determined by the instruction number count part 23, and the in-memory data residence time is determined by the in-memory data residence time count part 25.

The statistical analysis model 4 uses a first-order polynomial multiple regression analysis model.

According to the present embodiment, by generating in advance the statistical analysis model 4 as a radiation soft error rate model for a target logic device, it becomes possible to instantly evaluate the radiation soft error rates of a logic semiconductor device such as a processor, a microcomputer or the like and electronic equipment (electronic system) equipped with a logic semiconductor device, thereby making it possible to realize a short TAT for the evaluation. Further, since the irradiation evaluation can be done at one time, it is possible to realize a reduction in the cost of the irradiation evaluation. In addition, it is possible to carry out soft error evaluation at low cost and high speed in software updates via OTA, etc., which makes it possible to contribute even to improving the reliability of the electronic system.

### REFERENCE SIGNS LIST

1: soft error rate evaluation system, 2: program feature amount (first feature amount), 3a, 3b: program feature amount extraction part, 4: statistical analysis model, 5: statistical modeling processing part, 6: program feature amount (second feature amount), 7: soft error rate of evaluation target program, 8: soft error rate calculation processing part, 9: soft error rate for each program, 10: irradiation evaluation program, 11: program input conditions, 12: evaluation target program, 13: evaluation target program input conditions, 21: program simulation execution part, 22: trace data, 23: instruction number count part, 24: instruction number for each instruction type, 25: in-memory data residence time count part, 26: in-memory data residence time, 31: execution timing of instruction, 32: execution instruction

What is claimed is:

1. A soft error rate evaluation system evaluating the radiation resistance of electronic equipment which adopts a logic semiconductor device, comprising:
(a) a procedure of extracting a first feature amount at the time of execution of each of a plurality of irradiation evaluation programs from the plurality of irradiation evaluation programs and their program input conditions;
(b) a statistical analysis modeling procedure of performing statistical analysis modeling from the first feature amount of each of the plurality of irradiation evaluation programs and a soft error rate for each of the plurality of irradiation evaluation programs obtained in a neutron irradiation test conducted in advance, to generate a statistical analysis model;
(c) a procedure of extracting a second feature amount at the time of execution of an evaluation target program from the evaluation target program and its program input conditions; and
(d) a soft error rate calculation procedure of calculating a soft error rate of the evaluation target program from the second feature amount of the evaluation target program by using the statistical analysis model.

2. The soft error rate evaluation system according to claim 1, wherein
the first feature amount and the second feature amount include at least the number of executions of each instruction, which is a feature amount corresponding to the soft error rate for each functional block included in the logic semiconductor device, and an in-memory data residence time.

3. The soft error rate evaluation system according to claim 1, wherein
the statistical analysis model is a first-order polynomial multiple regression analysis model.

4. The soft error rate evaluation system according to claim 2, wherein
the statistical analysis model is a first-order polynomial multiple regression analysis mode.
